(19) United States
(12) Patent Application Publication
(10) Pub. No.: US 2021/0320293 A1
(43) Pub. Date: Oct. 14, 2021

(54) METHOD FOR RECOVERING LITHIUM BATTERY ACTIVE CATHODE MATERIAL FROM CATHODE WASTE

(71) Applicant: UCHICAGO ARGONNE, LLC, Chicago, IL (US)

(72) Inventors: Albert L. LIPSON, Oak Park, IL (US); Jessica L. DURHAM, Braidwood, IL (US)

(21) Appl. No.: 16/846,967

(22) Filed: Apr. 13, 2020

(51) Int. Cl. H01M 4/36; H01M 4/62; H01M 4/04; H01M 4/131; H01M 4/133; H01M 4/525; H01M 4/505; H01M 4/66; H01M 2/16; H01M 10/0525

(52) U.S. Cl. CPC H01M 4/364; H01M 4/623; H01M 4/0471; H01M 4/131; H01M 4/133; H01M 2004/021; H01M 4/505; H01M 4/661; H01M 2/1673; H01M 10/0525; H01M 4/525

(57) ABSTRACT

A method for recovering and recycling a cathode active material comprises combining a cathode waste from a lithium battery cathode waste stream with lithium-containing compound (e.g., lithium hydroxide) to form a reaction mixture; wherein the cathode waste comprises carbon, a fluorinated polymeric binder, and a cathode material selected from the group consisting of a lithiated cathode material and a delithiated cathode material; heating the reaction mixture in a stream of oxygen-containing gas to a temperature and for a period of time sufficient to burn off the carbon and the binder, to lithiate any delithiated cathode material present in the cathode waste, and for lithium in the reaction mixture to capture fluoride formed from decomposition of the binder; cooling the reaction mixture to ambient room temperature; and recovering the lithiated cathode active material.

### CONTRACTUAL ORIGIN OF THE INVENTION

The United States Government has rights in this invention pursuant to Contract No. DE-AC02-06CH11357 between the United States Government and UChicago Argonne, LLC representing Argonne National Laboratory.

### FIELD OF THE INVENTION

This invention relates to methods for recovering lithiated cathode active materials from lithium battery manufacturing waste and discarded lithium battery waste.

### BACKGROUND

Current cathodes for lithium batteries generally are formed from a cathode active composition in a discharged state (i.e., fully lithiated) coated onto a metal foil current collector (e.g., aluminum foil). Lithium and lithium-ion cells and batteries utilize lithium ion (Li⁺) as the charge carrying species of the electrolyte. A typical cathode active composition for a lithium battery comprises particles of a lithium transition metal oxide and carbon (e.g., carbon black) bound to a current collector by a fluorinated polymeric binder such as poly(vinylidene difluoride) (PVDF).

Lithium battery cathodes are manufactured in sheets, and individual cathodes are cut from the sheets. During battery manufacturing, trimmings from the cathode sheets currently are discarded, despite the high cost of the lithium transition metal oxide component of the cathode. Theoretically, the lithium transition metal oxide could be recovered from the trimmings by burning off the carbon and the binder. Ideally the recovered material would have the same chemical composition as the cathode material in the trimmings, so that it can be reused in the same cathode formulation. In practice, however, recovered cathode active materials from such thermal carbon and binder removal suffer from capacity and rate performance losses, which may be due to reactions of the lithium metal oxide with fluoride (e.g., as HF) generated from combustion of the fluorinated binder, which can lead to a cascade of reactions that can alter the chemical composition of the lithium transition metal oxide. In such cases, the recovered product may not be suitable for reuse in the same lithium battery cathode formulation or may not be suitable for cathode use at all.

A similar problem exists when trying to recycle cathodes from used lithium batteries, which is further exacerbated by the fact that the cathodes generally are at least partially delithiated compared to the pristine (i.e., freshly prepared) cathode active materials. In order to recover a useful cathode material from recycled cathodes, the delithiated materials must also be relithiated.

Because of problems described above, there are ongoing needs for new methods for recovering cathode active materials from lithium battery manufacturing waste and for recycling cathode materials from used lithium batteries. The methods described herein address these needs.

### SUMMARY

A method for recovering and recycling a lithiated cathode active material is described herein. In one embodiment, the method comprises combining a cathode composition from a lithium battery cathode waste with a lithium compound (e.g., lithium hydroxide hydrate, LiOH.H₂O) to form a reaction mixture; wherein the cathode composition comprises carbon, a fluorinated polymeric binder, and a cathode material selected from the group consisting of a lithiated cathode compound and a delithiated cathode compound. The next step is heating the reaction mixture under an oxygen-containing atmosphere (e.g., a stream of air or oxygen) to a temperature and for a period of time sufficient to burn off the carbon and the binder, to lithiate any delithiated cathode compound present in the cathode composition, and to sequester fluoride formed from decomposition of the binder as a lithium compound (e.g., LiF, lithium manganese oxyfluoride (where some Mn is removed from the cathode compound), or some other salt). The reaction mixture is then cooled to ambient room temperature, and the lithiated cathode active material is recovered.

Lithiated cathode active materials from cathode scrap (e.g., from lithium battery manufacturing) can be recovered according to the methods described herein in a form that performs surprisingly similar to the pristine cathode material when formed into a cathode laminate and tested in a lithium half-cell. Lithiated cathode active materials recovered from delithiated cathodes (e.g., from used lithium batteries) also can be recovered in a form that performs surprisingly similar to a pristine cathode material when formed into a cathode laminate and tested in a lithium half-cell. The recovered cathode active materials from the methods described herein also perform significantly better than the corresponding pristine cathode material heated to remove the carbon and binder without added lithium compound (e.g., lithium hydroxide hydrate).

In some preferred embodiments, the lithiated cathode material to be recovered or recycled is a lithium transition metal oxide, such as LiMO₂, wherein M is Ni, Mn, Co or a combination of two or more thereof, or a delithiated form thereof, e.g., Li₁₋ₓMO₂, wherein 0<x<0.5.

The following non-limiting embodiments of the methods described herein are provided below to illustrate certain aspects and features of the compositions and methods described herein.

Embodiment 1 is a method for recovering and recycling a cathode active material comprising the steps of: (a) combining a cathode composition from lithium battery cathode waste with a lithium-containing compound (e.g., a decomposable lithium salt) to form a reaction mixture; wherein the cathode composition comprises carbon, a fluorinated polymeric binder, and a cathode material selected from the group consisting of a lithiated cathode compound and a delithiated cathode compound; (b) heating the reaction mixture under an oxygen-containing atmosphere to a temperature and for a period of time sufficient to burn off the carbon and the binder, to lithiate any delithiated cathode compound present in the cathode waste, and for lithium present in the reaction mixture to sequester fluoride formed from decomposition of the binder; (c) cooling the reaction mixture to ambient room temperature; and (d) recovering the lithiated cathode active material.

Embodiment 2 is a method for recovering a lithiated cathode active material from lithium battery manufacturing cathode scrap comprising the steps of: (a) combining a cathode composition obtained from the cathode scrap with about 1 to about 5 wt % of a decomposable lithium salt, based on the weight of a lithium metal oxide in the cathode composition, to form a reaction mixture; wherein the cathode composition comprises carbon, a fluorinated polymeric binder, and the lithium transition metal oxide; (b) heating the reaction mixture under an oxygen-containing atmosphere to a temperature of about 400 to 1000° C. at a heating rate of about 30 to about 300° C./hour, such that the carbon and the binder burn off, and lithium present in the reaction mixture sequesters fluoride formed from decomposition of the binder; (c) cooling the reaction mixture to ambient room temperature; and (d) recovering the lithiated cathode active material.

Embodiment 3 is the method of embodiment 2, wherein the decomposable lithium salt comprises at least one salt selected from the group consisting of lithium hydroxide hydrate, lithium carbonate, lithium nitrate, and a lithium salt of an organic acid.

Embodiment 4 is the method of embodiment 2, wherein the decomposable lithium salt comprises lithium hydroxide hydrate.

Embodiment 5 is the method of embodiment 2, wherein the reaction mixture is maintained at the temperature of about 400 to 1000° C. for up to about 12 hours prior to step (c).

Embodiment 6 is the method of embodiment 2, wherein the lithium transition metal oxide comprises a material of empirical formula LiMO₂, wherein M comprises a transition metal.

Embodiment 7 is the method of embodiment 6, wherein M comprises at least one transition metal selected from the group consisting of Ni, Mn, and Co.

Embodiment 8 is the method of embodiment 2, wherein the heating is performed in a fluidized bed reactor or a rotary kiln.

Embodiment 9 is the method of embodiment 2, wherein the binder comprises poly(vinylidene difluoride).

Embodiment 10 is a method for recovering a cathode active material from waste lithium battery cathodes comprising the steps of: (a) combining a cathode composition from cathode waste with about 1 to about 50 wt % a decomposable lithium salt, based on the weight of a delithiated cathode compound in the cathode composition, to form a reaction mixture; wherein the cathode composition comprises carbon, a fluorinated polymeric binder, and the delithiated cathode compound; (b) heating the reaction mixture under an oxygen-containing atmosphere to a temperature of about 500 to 1000° C. at a heating rate of about 30 to about 300° C./hour, such that the carbon and the binder burn off, the delithiated cathode compound is relithiated, and lithium present in the reaction mixture sequesters fluoride formed from decomposition of the binder; (c) cooling the reaction mixture to ambient room temperature; and (d) recovering the lithiated cathode active material.

Embodiment 11 is the method of embodiment 10, wherein the decomposable lithium salt comprises at least one salt selected from the group consisting of lithium hydroxide hydrate, lithium carbonate, lithium nitrate, and a lithium salt of an organic acid.

Embodiment 12 is the method of embodiment 10, wherein the decomposable lithium salt comprises lithium hydroxide hydrate.

Embodiment 13 is the method of embodiment 10, wherein the reaction mixture is maintained at the temperature of about 500 to 1000° C. for up to about 12 hours prior to step (c). Embodiment 14 is the method of embodiment 10, wherein the delithiated cathode compound comprises a lithium transition metal oxide that is at least partially delithiated.

Embodiment 15 is the method of embodiment 14, wherein the lithium transition metal oxide comprises at least one transition metal selected from the group consisting of Ni, Mn, and Co.

Embodiment 16 is the method of embodiment 10, wherein the delithiated cathode material comprises a composition of empirical formula Li₁₋ₓMO₂, wherein M comprises a transition metal, and 0<x<0.5.

Embodiment 17 is the method of embodiment 10, wherein the heating is performed in a fluidized bed reactor or a rotary kiln. Embodiment 18 is the method of embodiment 10, wherein the binder comprises poly(vinylidene difluoride).

Embodiment 19 is a cathode for a lithium battery comprising the lithiated cathode active material recovered in step (d) of the method of embodiment 1 and carbon coated on a metal current collector with a polymeric binder.

Embodiment 20 is a lithium electrochemical cell comprising an anode, the cathode of embodiment 19, a lithium conductive separator between the anode and the cathode, and a lithium containing electrolyte contacting the anode, the cathode, and the separator.

Embodiment 21 is a lithium battery comprising a plurality of the electrochemical cells of embodiment 20 electrically connected in series, in parallel, or in both series and parallel.

### BRIEF DESCRIPTION OF THE DRAWINGS

FIG. 1 shows a graph of heating temperature versus time for treating a simulated cathode waste comprising a pristine NMC111.

FIG. 2 shows a graph of heating temperature versus time for treating a simulated cathode waste comprising a chemically delithiated NMC111 cathode material.

FIG. 3 provides graphs of discharge capacity (mAh/g) versus cycle number from lithium half-cells formed with cathodes comprising a pristine NMC111 cathode composition processed at 500° C. with either 2 wt % or 4 wt % LiOH.H₂O, in comparison with cathodes formed from unprocessed pristine NMC111 and from pristine NMC111 processed at 500° C. without LiOH.H₂O.

FIG. 4 provides graphs of discharge capacity (mAh/g) versus cycle number from lithium half-cells formed with a cathode comprising a chemically delithiated NMC111 cathode composition with 3 wt % PVDF binder processed at 925° C. with 15 wt % LiOH.H₂O, in comparison with cathodes formed from a chemically delithiated NMC111 with no binder processed at 500° C. with 10 wt % LiOH.H₂O, from unprocessed pristine NMC111, and from pristine NMC111 with 3 wt % PVDC binder processed at 500° C. with 4 wt % LiOH.H₂O.

FIG. 5 depicts a schematic representation of an electrochemical cell.

FIG. 6 depicts a schematic representation of a battery consisting of a plurality of cells connected electrically in series and in parallel.

### DETAILED DESCRIPTION

Thermogravimetric analysis with mass spectroscopy was performed on a simulated cathode composition containing 92 wt % NMC111, 3 wt % PVDF binder and 5 wt % carbon black in order to follow mass and compositional changes in the material with increasing temperature. The chemical formulas in Scheme 1 illustrate some of the possible chemical reactions that can occur upon heating the cathode composition. PVDF decomposes at approximately 400° C. releasing fragments containing F (e.g., HF) along with H₂O and CO₂. Carbon black decomposes at approximately 500° C. There is also additional fluorine release above 900° C. that is indicative of the decomposition of NMC material that was doped with F during the binder removal process (e.g., LiNi_{0.33}Co_{0.33}Mn_{0.33}O_{1.5}F). One of the possible thermal reactions is removal of Li from the LiNi_{0.33}Co_{0.33}Mn_{0.33}O₂, which forms unstable Ni_{0.33}Co_{0.33}Mn_{0.33}O₂ and LiF. Release of oxygen from LiNi_{0.33}Co_{0.33}Mn_{0.33}O₂ forms a rock salt structure (MO stoichiometry): Ni_{0.33}Co_{0.33}Mn_{0.33}O. If a rock salt structure forms on the surfaces of the NMC, the impedance increases significantly, thereby reducing the capacity of the material. In a cathode active material recovery process, the undesirable formation of the rock salt phase needs to be avoided, as does formation of F-substituted lithium metal oxides, since the resulting product may not be able to be directly reused for making new cathodes of the same type.

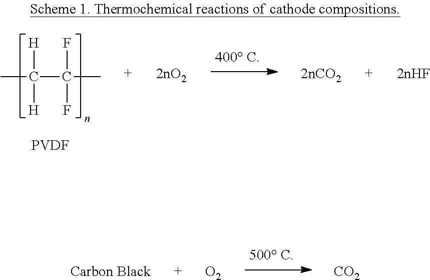

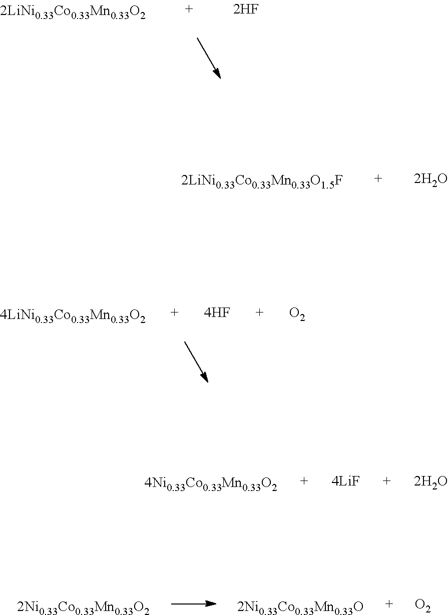

The terms “lithium cell” and “lithium battery” encompass cells and batteries in which the anode is lithium metal (sometimes also referred to as a “lithium half-cell”); while the terms “lithium-ion cell” and “lithium-ion battery” encompass cells and batteries in which the anode is something other than lithium metal (e.g., carbon, silicon, etc.). For convenience, the terms “lithium battery”, “lithium-ion battery”, and grammatical variations thereof, are used interchangeably herein, unless it is clear from the context that the more specific designation is meant. Similarly, the terms “lithium cell”, “lithium-ion cell”, and grammatical variations thereof, also are used interchangeably herein, unless it is clear from the context that the more specific designation is meant. The term “delithiated” is used herein to describe a cathode or cathode compound means that the cathode or cathode material contains less than its full capacity of lithium ions. Such delithiated materials may still retain some lithium within the structures thereof. As used herein, the term “relithiate” refers to adding lithium back into a delithiated material bring it to its full discharged state, or at least substantially so. As used herein, the term “sequester” and grammatical variations thereof means forming a compound that effectively keeps fluoride from reacting with the cathode active material or at least reduces the level of such reactions.

As described herein, adding a lithium compound such as LiOH.H₂O to a cathode composition comprising a lithium metal oxide, carbon, and fluorinated binder alters the cascade of reactions that occur during thermal processing by sequestering F as LiF or some other lithium-containing fluoride, thus ameliorating the delithiation reaction, and preserving the LiMO₂ structure of the cathode active material. This can be achieved with about 1 to about 5 wt % of the added lithium compound at temperatures of about 400 to about 1000° C. This same effect can be extended to recycling delithiated cathodes, in which case larger quantities of added lithium compound (1 to about 50 wt %) and higher temperatures (about 500 to about 1000° C.) may be required in order to relithiate the cathode material while also sequestering F. Some F generally remains in the recovered cathode active material, but much less than when the lithium compound is omitted.

The methods described herein provide effective processes for recovering cathode active materials from lithium-ion battery waste streams. In one embodiment, a method for recovering and recycling a lithiated cathode active material comprises combining a cathode composition from a lithium battery cathode waste with a lithium compound such as lithium hydroxide hydrate to form a reaction mixture. The cathode composition comprises carbon (e.g., carbon black, acetylene black, graphite, carbon fibers, carbon nanotubes, carbon nanofibers, and the like), a fluorinated polymeric binder, and a cathode compound selected from the group consisting of a lithiated cathode compound and a delithiated cathode compound. The reaction mixture is heated under an oxygen-containing atmosphere (e.g., a stream of air or oxygen) to a temperature and for a period of time sufficient to burn off the carbon and the binder, to lithiate any delithiated cathode compound present in the cathode waste, and to sequester fluoride formed from decomposition of the binder as a lithium compound, such as lithium fluoride. After cooling the reaction mixture to ambient room temperature, the lithiated cathode active material can be recovered for reuse in lithium battery cathodes.

As noted above, when a lithium transition metal oxide is recovered from scrap lithium battery cathode trimmings the added lithium compound preferably is present in the reaction mixture at a concentration of about 1 to about 5 percent by weight (wt %), based on weight of the lithiated cathode material present in the reaction mixture. During processing, the reaction mixture preferably is heated to a temperature of about 400 to 1000° C. at a heating rate in the range of about 30 to about 300° C/hour, and can be maintained a temperature of about 400 to 1000° C. prior to cooling, if desired.

When a delithiated transition metal oxide is to be recycled from used lithium battery cathodes the added lithium compound (e.g., lithium hydroxide hydrate) preferably is present in the reaction mixture at a concentration of about 1 to about 50 percent by weight (wt %), based on weight of the delithiated cathode material present in the reaction mixture and the degree of delithiation. During processing, the reaction mixture preferably is heated to a temperature of about 500 to 1000° C. at a heating rate in the range of about 30 to about 300° C./hour, and can be maintained a temperature of about 500 to 1000° C. prior to cooling, if desired.

In the methods described herein, the specific temperature, heating rate, and amount of lithium compound to be added to the reaction mixture is selected based on the particular cathode composition to be treated, using routine and well-known chemical process optimization principles. For example, highly delithiated cathode compounds or compositions that include a high level of fluorinated binder likely will require more added lithium compound and perhaps higher temperature than treatment of similar compositions comprising a pristine lithiated cathode material and/or lower a binder level. Similarly, different lithium transition metal oxide cathode materials may require different temperatures, heating rates and the like, due to inherent differences in, e.g., the rates and activation energies of the chemical reactions involved.

In order to process the cathode materials in the methods described herein, the active coating is separated from the underlying metal current collector, e.g., by mechanical, chemical, or thermal methodologies. This can be performed in a separate operation or can be integrated into the recovery/recycling process described herein. For example, mechanical grinding or agitation can be used remove the active layer from the current collector, and sieving or some other particle separation technique can be used to isolate the removed active layer from the current collector material (e.g., aluminum foil). The active layer material is then ground up and mixed with a lithium compound (e.g., a decomposable lithium salt), such as lithium hydroxide hydrate, lithium carbonate, lithium nitrate, a lithium salt of an organic acid (e.g., lithium acetylacetonate, or lithium formate), and the like, and the resulting reaction mixture is heated to the appropriate temperature and for the appropriate time period to achieve the desired removal of carbon and binder, sequestration of the fluoride, and relithiation in the case of delithiated cathodes.

The heating can be accomplished in any type of reactor capable of achieving the temperatures necessary for the reactions and which is suitable for exposure to fluorine compounds. Because of the fluoride and HF, formed during the process, and the high temperatures involved, the reactor may need to be lined with or made of a fluoride resistant alloy such as a nickel chromium alloy, of other such materials, which are well known in the chemical processing arts. The reactor could be of a type to allow mixing during the processing, such as a fluidized bed reactor or rotary kiln.

As used herein, the term “fluorinated polymeric binder” refers to any polymer that can be utilized as a binder in a lithium battery and which contains fluorine substituents, such as poly(vinylidene difluoride) which is also referred to as poly(vinylidene fluoride) or PVDF, copolymers comprising vinylidene difluoride monomer units, polymers or copolymers comprising tetrafluoroethylene monomer units, polymers or copolymers comprising hexafluoropropylene monomer units, fluorinated polyimides, and the like.

In some embodiments, the pristine cathode active material to be recovered (or the equivalent lithiated form of a cathode material to be recycled from used batteries) comprises a layered lithium metal oxide cathode material such as LiMO₂ wherein M comprises one or more transition metals (e.g., Mn, Ni, Co or a combination thereof), for example, a layered lithium nickel-manganese-cobalt oxide such as LiNi_{0.33}Co_{0.33}Mn_{0.33}O₂ (also known as “NMC333” or “NMC111”), LiNi_{0.5}Co_{0.3}CO_{0.2}O₂ (also known as “NMC532”), LiNi_{0.6}Mn_{0.2}CO_{0.2}O₂ (also known as “NMC622”), and similar materials. In other embodiments, the cathode can comprise a spinel lithium metal oxide such as Li₂M′₂O₄ wherein M′ comprises one or more transition metals (e.g., Mn, Ni, Co or a combination thereof); a structurally integrated layered-layered (LL) lithium metal oxide such as xLi₂MnO₃.(1-x)LiMn_{y}M_{1-y}O₂ wherein 0<x<1, 0≤y≤1, M=Ni, Co, or Ni and Co; a structurally integrated layered-spinel (LS) lithium metal oxide such as xLi₂MnO₃.(1-x)Li₂Mn_{y}M_{2-y}O₄ wherein 0<x<1, 0≤y≤2, M=Ni, Co, or Ni and Co; a structurally integrated layered-layered-spinel (LLS) lithium metal oxide such as z[xLi₂MnO₃.Li₂Mn_{y}M_{2-y}O₄].(1-z)Li₂M′₂O₄ wherein 0<x<1, 0≤y≤1, 0<z<1, M=Ni, Co, or Ni and Co, and M′=Mn, Ni, Co or a combination thereof (e.g., 0.85[0.25Li₂MnO₃.(0.75)LiMn_{0.375}Ni_{0.375}Co_{0.25}O₂].15Li₂M′₂O₄ wherein M′=a combination Mn, Ni, and Co); or any other lithium transition metal oxide cathode active material used in lithium-ion batteries.

As used herein, a structurally-integrated composite metal oxide is a material that includes domains (e.g., locally ordered, nano-sized or micro-sized domains) indicative of different metal oxide compositions having different crystalline forms (e.g., layered or spinel forms) within a single particle of the composite metal oxide, in which the domains share substantially the same oxygen lattice and differ from each other by the elemental and spatial distribution of metal ions in the overall metal oxide structure. Structurally-integrated composite metal oxides are different from and generally have different properties than mere mixtures of two or more metal oxide components (for example, mere mixtures do not share a common oxygen lattice).

The recovered and recycled cathode active materials provided by the methods described herein can be utilized in cathodes for new batteries. Cathodes typically are formed by combining a powdered mixture of the active material and some form of carbon (e.g., carbon black, with a binder such as (polyvinylidene difluoride (PVDF), carboxymethylcellulose, and the like) in a solvent (e.g., N-methylpyrrolidone (NMP) and the resulting mixture is coated on a conductive current collector (e.g., aluminum foil) and dried to remove solvent and form an active layer on the current collector.

Cathodes comprising the recovered and recycled lithiated cathode active materials described herein can be used to manufacture a lithium-ion electrochemical cell. Such cells typically comprise the cathode, an anode capable of reversibly releasing and accepting lithium or lithium-ion during discharging and charging, respectively, and a porous separator between the cathode and anode, with an electrolyte in contact with both the anode and cathode, as is well known in the battery art. A battery can be formed by electrically connecting two or more such electrochemical cells in series, parallel, or a combination of series and parallel. Electrochemical cells and battery designs and configurations, anode and cathode materials, as well as electrolyte salts, solvents and other battery or electrode components (e.g., separator membranes, current collectors), which can be used in the electrolytes, cells and batteries described herein, are well known in the secondary battery art, e.g., as described in “Lithium Batteries Science and Technology” Gholam-Abbas Nazri and Gianfranco Pistoia, Eds., Springer Science+Business Media, LLC; New York, N.Y. (2009), which is incorporated herein by reference in its entirety (Nazri 2009).

Processes used for manufacturing lithium cells and batteries also are well known in the art. The active electrode materials are coated on both sides of metal foil current collectors (typically copper for the anode and aluminum for the cathode) with suitable binders such as polyvinylidene difluoride and the like to aid in adhering the active materials to the current collectors. Cell assembly typically is carried out on automated equipment. The first stage in the assembly process is to sandwich a separator between the anode. The cells can be constructed in a stacked structure for use in prismatic cells, or a spiral wound structure for use in cylindrical cells. The electrodes are connected to terminals and the resulting sub-assembly is inserted into a casing, which is then sealed, leaving an opening for filling the electrolyte into the cell. Next, the cell is filled with the electrolyte and sealed under moisture-free conditions.

Once the cell assembly is completed the cell typically is subjected to at least one controlled charge/discharge cycle to activate the electrode materials and in some cases form a solid electrolyte interface (SEI) layer on the anode. This is known as formation cycling. The formation cycling process is well known in the battery art and involves initially charging with a low voltage (e.g., substantially lower that the full-cell voltage) and gradually building up the voltage. The SEI acts as a passivating layer, which is essential for moderating the charging process under normal use. The formation cycling can be carried out, for example, according to the procedure described in Long et al. J. Electrochem. Soc., 2016; 163 (14): A2999-A3009, which is incorporated herein by reference in its entirety. This procedure involves a 1.5 V tap charge for 15 minutes at C/3 current limit, followed by a 6-hour rest period, and then 4 cycles at C/10 current limit, with a current cutoff (i≤0.05 C) at the top of each charge.

Electrodes comprising the recycled or recovered lithiated cathode active materials described herein, can be utilized with any combination of anode and electrolyte in any type of rechargeable battery system that utilizes a non-aqueous electrolyte. Anodes for the electrochemical cells and batteries typically comprise materials that can reversibly accept and release lithium during charging and discharging, respectively, such as carbon (e.g., carbon black), silicon, silicon oxides, lithium titanate, and the like (see e.g., Nazri, 2009, referred to above).

Typically, the electrolyte comprises an electrolyte salt (e.g., an electrochemically stable lithium salt) dissolved in a non-aqueous solvent. Any lithium electrolyte salt can be utilized in the electrolyte compositions for lithium electrochemical cells and batteries, such as the salts described in Jow et al. (Eds.), Electrolytes for Lithium and Lithium-ion Batteries; Chapter 1, pp. 1-92; Springer; New York, N.Y. (2014), which is incorporated herein by reference in its entirety.

Non-limiting examples of lithium salts include, e.g., lithium bis(trifluoromethanesulfonyl)imidate (LiTFSI), lithium 2-trifluoromethyl-4,5-dicyanoimidazolate (LiTDI), lithium 4,5-dicyano-1,2,3-triazolate (LiDCTA), lithium trifluoromethanesulfonate (LiTf), lithium perchlorate (LiClO₄), lithium bis(oxalato)borate (LiB(C₂O₄)₂ or “LiBOB”), lithium difluoro(oxalato)borate (LiF₂BC₂O₄ or “LiDFOB”), lithium tetrafluoroborate (LiBF₄), lithium hexafluorophosphate (LiPF₆), lithium hexafluoroarsenate (LiAsF₆), lithium thiocyanate (LiSCN), lithium bis(fluorosulfonyl)imidate (LiFSI), lithium bis(pentafluoroethylsulfonyl)imidate (LiBETI), lithium tetracyanoborate (LiB(CN)₄), lithium nitrate, combinations of two or more thereof, and the like. The lithium salt can be present in the electrolyte solvent at any concentration suitable for lithium battery applications, which concentrations are well known in the secondary battery art. In some embodiments, the lithium salt is present in the electrolyte at a concentration in the range of about 0.1 M to about 5 M, e.g., about 0.5 M to 2 M, or 1 M to 1.5M.

The non-aqueous solvent for the electrolyte compositions include the solvents described in Jow et al. (Eds.), Electrolytes for Lithium and Lithium-ion Batteries; Chapter 2, pp. 93-166; Springer; New York, N.Y. (2014), which is incorporated herein by reference in its entirety. Non-limiting examples of solvents for use in the electrolytes include, e.g., an ether, a carbonate ester (e.g., a dialkyl carbonate or a cyclic alkylene carbonate), a nitrile, a sulfoxide, a sulfone, a fluoro-substituted linear dialkyl carbonate, a fluoro-substituted cyclic alkylene carbonate, a fluoro-substituted sulfolane, and a fluoro-substituted sulfone. For example, the solvent can comprise an ether (e.g., glyme or diglyme), a linear dialkyl carbonate (e.g., dimethyl carbonate (DMC), diethyl carbonate (DEC), ethyl methyl carbonate (EMC) and the like), a cyclic alkylene carbonate (ethylene carbonate (EC), propylene carbonate (PC) and the like), a sulfolane (e.g., sulfolane or an alkyl-substituted sulfolane), a sulfone (e.g., a dialkyl sulfone such as a methyl ethyl sulfone), a fluoro-substituted linear dialkyl carbonate, a fluoro-substituted cyclic alkylene carbonate, a fluoro-substituted sulfolane, and a fluoro-substituted sulfone. The solvent can comprise a single solvent compound or a mixture of two or more solvent compounds.

In some embodiments, the non-aqueous solvent for a lithium electrochemical cell as described herein can be an ionic liquid. Any electrochemically stable ionic liquid solvent can be utilized in the electrolytes described herein, such as the solvents described in Jow et al. (Eds.), Electrolytes for Lithium and Lithium-ion Batteries; Chapter 4, pp. 209-226; Springer; New York, N.Y. (2014), which is incorporated herein by reference in its entirety. In the case of lithium electrochemical cells and batteries, the ionic liquid can optionally include a lithium cation, and can act directly as the electrolyte salt. Similarly, in the case of sodium electrochemical cells and batteries, the ionic liquid can optionally include a sodium cation, and can act directly as the electrolyte salt.

The electrolyte compositions for lithium electrochemical cells and batteries also can optionally comprise an additive such as those described in Jow et al. (Eds.), Electrolytes for Lithium and Lithium-ion Batteries; Chapter 3, pp. 167-182; Springer; New York, N.Y. (2014), which is incorporated herein by reference in its entirety. Such additives can provide, e.g., benefits such as SEI, cathode protection, electrolyte salt stabilization, thermal stability, safety enhancement, overpotential protection, corrosion inhibition, and the like. The additive can be present in the electrolyte at any concentration, but in some embodiments is present at a concentration in the range of about 0.0001 M to about 0.5 M. In some embodiments, the additive is present in the electrolyte at a concentration in the range of about 0.001 M to about 0.25 M, or about 0.01 M to about 0.1 M.

The following non-limiting Examples are provided to illustrate certain features of the compositions and methods described herein.

### EXAMPLE 1

### Thermal Processing of Cathode Compositions Comprising PVDF with LiOH.H₂O to Remove Carbon and Binder

As described herein, adding a lithium compound, such as LiOH.H₂O, to a cathode composition comprising a fluorinated binder prior to thermal processing can alter the chemical reactions that occur during thermal processing to sequester F generated by combustion of the binder. Sequestering the F (e.g., as LiF) helps prevent undesired side effects of binder fluoride on the cathode active material in the cathode composition. In the case of delithiated cathode materials a larger amount of added lithium compound (e.g., LiOH.H₂O) is used, compared to the amount used for lithiated cathode materials, in order to relithiate the cathode active material in addition to sequestering at least some of the fluorine.

Simulated cathode compositions were prepared and thermally treated, with and without LiOH.H₂O to demonstrate various aspects of the methods described herein.

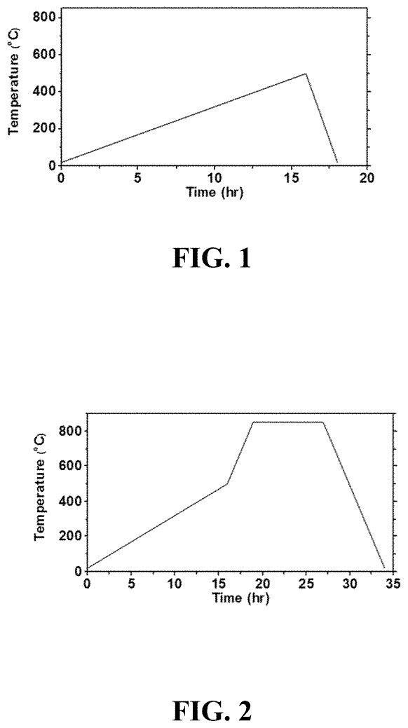

FIG. 1 shows a heating profile (a graph of temperature versus time) for treating simulated cathode compositions comprising pristine NMC111, carbon, and PVDF binder, e.g., to simulate materials obtained from cathode scrap (e.g., cathode trimmings from battery manufacture). The composition that was prepared and tested included pristine NMC111 with 3 wt % PVDF, and 5 wt % carbon black, which was mixed with NMP solvent and coated onto aluminum foil. After drying, the coating was scraped off, ground up, mixed with either 2 wt % or 4 wt % LiOH.H₂O. The resulting mixture was then heated in a muffle furnace with a 200 L/hr stream of air according to the heating profile in FIG. 1 to burn off the carbon and PVDF, and a lithiated cathode material was then recovered after cooling. For comparison, a pristine NMC111 cathode composition was processed under the same conditions without LiOH.H₂O.

Chemical delithiation can be used to simulate the loss of Li during cycling. This is accomplished by mixing the NMC material with a chemical oxidant, potassium persulfate, at 50° C. for 15 hr. Compositions containing chemically delithiated NMC111, carbon, and PVDF binder, were prepared to simulate materials obtained from used cathodes (e.g., cathode to be recycled from discarded batteries). A composition comprising the delithiated NMC111, 3 wt % PVDF, and 5 wt % carbon black, was mixed with NMP solvent and coated onto aluminum foil. After drying, the coating was scraped off, and ground up for processing under various conditions.

In order to evaluate the effects of heating the delithiated composition under the same conditions as lithiated heating conditions, the delithiated cathode composition was mixed with 15 wt % LiOH.H₂O and heated in a stream of air according to the heating profile in FIG. 1 (i.e., conditions for the lithiated materials) to burn off the carbon and PVDF, and the resulting cathode material was then recovered after cooling. To test relithiation without binder the delithiated cathode material was mixed with 10 wt % LiOH.H₂O H₂O and heated in a stream of air according to the heating profile in FIG. 1. In other experiments, the delithiated composition with 3 wt % PVDF binder and 5 wt % carbon black was heated up to 925° C. according to the heating profile in FIG. 2, with 15 wt % LiOH.H₂O. The cathode materials were recovered after cooling to ambient room temperature.

### EXAMPLE 2

### Electrochemical Evaluation of Recovered and Recycled Lithiated Cathode Active Materials

The cathode materials prepared in Example 1 were sieved using a 45 μm sieve, and then were mixed with 5 wt % TIMCAL SUPER C45 carbon black and 5 wt % PVDF with sufficient NMP solvent to form a slurry. This slurry was coated onto aluminum foil and dried at 80° C. in air. Electrodes were punched, calendered, and then further dried at 80° C. under vacuum in an argon-filled glovebox. Lithium half-cells were then prepared in that glovebox using lithium metal anodes and an electrolyte comprising 1.2 M LiPF₆ in 3:7 ethylene carbonate to ethyl methyl carbonate by volume. The cells were tested in triplicate in a MACCOR battery cycler at 30° C. A 1 C rate was assumed to be 160 mA/g.

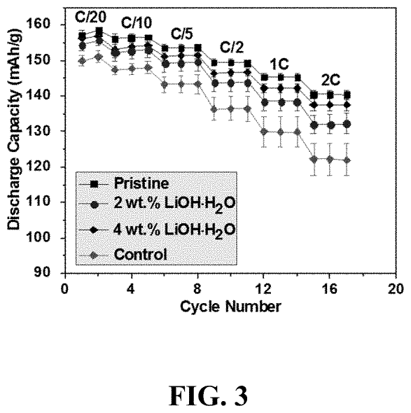

FIG. 3 provides graphs of discharge capacity (mAh/g) versus cycle number from lithium half-cells formed with cathodes comprising pristine NMC111 processed at 500° C. with either 2 wt % or 4 wt % LiOH.H₂O, in comparison with cathodes formed from unprocessed pristine NMC111 and from pristine NMC111 processed at 500° C., but without LiOH.H₂O.

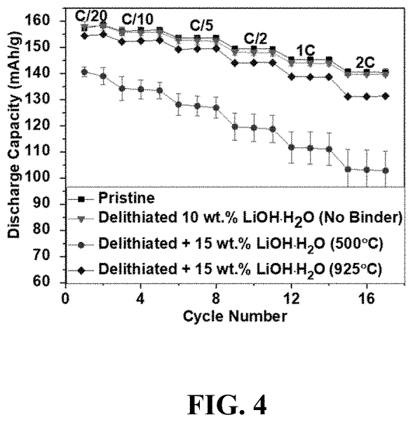

FIG. 4 provides graphs of discharge capacity (mAh/g) versus cycle number from lithium half-cells formed with a cathode comprising a chemically delithiated NMC111 cathode composition with 3 wt % PVDF binder processed at 925° C. with 15 wt % LiOH.H₂O, in comparison with cathodes formed from a chemically delithiated NMC111 with no binder processed at 500° C. with 10 wt % LiOH.H₂O, from unprocessed pristine NMC111, and from pristine NMC111 with 3 wt % PVDC binder processed at 500° C. with 4 wt % LiOH.H₂O.

### Discussion.

The results in FIG. 3 demonstrate that the addition of LiOH.H₂O substantially improves the performance of the cathode material after binder removal. With 4 wt.% LiOH.H₂O the initial capacity and rate performance of recovered NMC111 processed at 500° C. are similar to that of the pristine material. This is an indication that the cathode is not substantially doped by fluorine after the process is completed. In a separate experiment, a cathode composition comprising NMC622 processed in a similar manner required a temperature of 750° C. to obtain comparable recovered cathode material, demonstrating that different cathode compounds may require different processing parameters. The 750° C. processing temperature for NMC622 was determined by routine process optimization experiments.

Delithiated materials create an additional challenge since they are more structurally unstable than the pristine lithiated materials. This results in the formation of either spinel or rock salt structure upon heating. The results in FIG. 4 show that that it is straightforward to relithiate the 10% chemically delithiated NMC 111 through the addition of 10 wt.% LiOH.H₂O using a heat treatment to 500° C. without any fluorinated binder present. However, if an attempt is made to relithiate during binder removal, with enough LiOH.H₂O to compensate for both the delithiation and F sequestration, the resulting capacity is poor. However, if the material is annealed at higher temperatures the capacities improves, since the increased temperature allows for the decomposed NMC to be reformed into a layered structure. Based on results from thermogravimetric analysis with mass spectroscopy, additional fluorine that has doped the structure can be released at these temperatures, thus further improving the performance of the cathode material.

### EXAMPLE 5

### Electrochemical Cells and Batteries

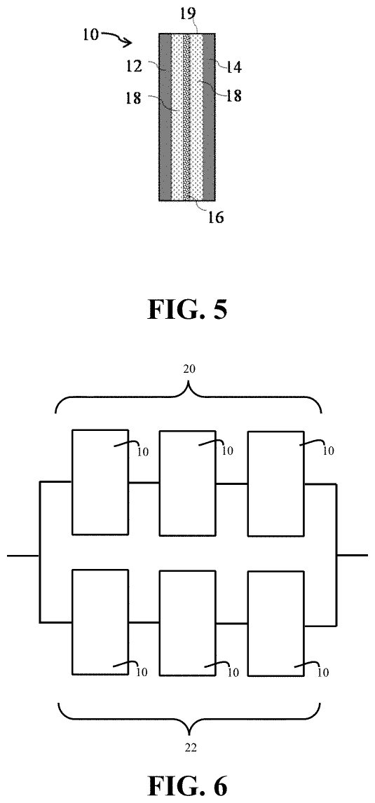

FIG. 5 schematically illustrates a cross-sectional view of an electrochemical cell 10 includes anode 12, and cathode 14 comprising a recovered or recycled lithium metal oxide cathode material as described herein, with separator 16 between anode 12 and cathode 14. A lithium-containing electrolyte 18, comprising a solution of a lithium salt in a non-aqueous solvent, contacts anode 12, cathode 14 and separator 16. The anode, cathode, separator and electrolyte are sealed within housing 19. FIG. 6 schematically illustrates a lithium-ion battery comprising a first array 20 consisting of three series-connected electrochemical cells 10, and a second array 22 consisting of three series-connected electrochemical cells 10, in which first array 20 is electrically connected to second array 22 in parallel.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The terms “consisting of” and “consists of” are to be construed as closed terms, which limit any compositions or methods to the specified components or steps, respectively, that are listed in a given claim or portion of the specification. In addition, and because of its open nature, the term “comprising” broadly encompasses compositions and methods that “consist essentially of” or “consist of” specified components or steps, in addition to compositions and methods that include other components or steps beyond those listed in the given claim or portion of the specification. Recitation of ranges of values herein are merely intended to serve as a shorthand method of referring individually to each separate value falling within the range, unless otherwise indicated herein, and each separate value is incorporated into the specification as if it were individually recited herein. All numerical values obtained by measurement (e.g., weight, concentration, physical dimensions, removal rates, flow rates, and the like) are not to be construed as absolutely precise numbers, and should be considered to encompass values within the known limits of the measurement techniques commonly used in the art, regardless of whether or not the term “about” is explicitly stated. All methods described herein can be performed in any suitable order unless otherwise indicated herein or otherwise clearly contradicted by context. The use of any and all examples, or exemplary language (e.g., “such as”) provided herein, is intended merely to better illuminate certain aspects of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The embodiments of the invention in which an exclusive property or privilege is claimed are defined as follows:

1. A method for recovering and recycling a cathode active material comprising the steps of:
(a) combining a cathode composition from lithium battery cathode waste with a lithium-containing compound to form a reaction mixture; wherein the cathode composition comprises carbon, a fluorinated polymeric binder, and a cathode material selected from the group consisting of a lithiated cathode compound and a delithiated cathode compound;
(b) heating the reaction mixture under an oxygen-containing atmosphere to a temperature and for a period of time sufficient to burn off the carbon and the binder, to lithiate any delithiated cathode compound present in the cathode waste, and for lithium present in the reaction mixture to sequester fluoride formed from decomposition of the binder;
(c) cooling the reaction mixture to ambient room temperature; and
(d) recovering the lithiated cathode active material.

2. A method for recovering a lithiated cathode active material from lithium battery manufacturing cathode scrap comprising the steps of:
(a) combining a cathode composition obtained from the cathode scrap with about 1 to about 5 wt % a decomposable lithium salt, based on the weight of a lithium metal oxide in the cathode composition, to form a reaction mixture; wherein the cathode composition comprises carbon, a fluorinated polymeric binder, and the lithium transition metal oxide;
(b) heating the reaction mixture under an oxygen-containing atmosphere to a temperature of about 400 to 1000° C. at a heating rate of about 30 to about 300° C/hour, such that the carbon and the binder burn off, and lithium present in the reaction mixture sequesters fluoride formed from decomposition of the binder;
(c) cooling the reaction mixture to ambient room temperature; and
(d) recovering the lithiated cathode active material.

3. The method of claim 2, wherein the decomposable lithium salt comprises at least one salt selected from the group consisting of lithium hydroxide hydrate, lithium carbonate, lithium nitrate, and a lithium salt of an organic acid.

4. The method of claim 2, wherein the decomposable lithium salt comprises lithium hydroxide hydrate.

5. The method of claim 2, wherein the reaction mixture is maintained at the temperature of about 400 to 1000° C. for up to about 12 hours prior to step (c).

6. The method of claim 2, wherein the lithium transition metal oxide comprises a material of empirical formula LiMO₂, wherein M comprises a transition metal.

7. The method of claim 6, wherein M comprises at least one transition metal selected from the group consisting of Ni, Mn, and Co.

8. The method of claim 2, wherein the heating is performed in a fluidized bed reactor or a rotary kiln.

9. The method of claim 2, wherein the binder comprises poly(vinylidene difluoride).

10. A method for recovering a cathode active material from waste lithium battery cathodes comprising the steps of:
(a) combining a cathode composition from cathode waste with about 1 to about 50 wt % a decomposable lithium salt, based on the weight of a delithiated cathode compound in the cathode composition, to form a reaction mixture; wherein the cathode composition comprises carbon, a fluorinated polymeric binder, and the delithiated cathode compound;
(b) heating the reaction mixture under an oxygen-containing atmosphere to a temperature of about 500 to 1000° C. at a heating rate of about 30 to about 300° C./hour, such that the carbon and the binder burn off, the delithiated cathode compound is relithiated, and lithium present in the reaction mixture sequesters fluoride formed from decomposition of the binder;
(c) cooling the reaction mixture to ambient room temperature; and
(d) recovering the lithiated cathode active material.

11. The method of claim 10, wherein the decomposable lithium salt comprises at least one salt selected from the group consisting of lithium hydroxide hydrate, lithium carbonate, lithium nitrate, and a lithium salt of an organic acid.

12. The method of claim 10, wherein the decomposable lithium salt comprises lithium hydroxide hydrate.

13. The method of claim 10, wherein the reaction mixture is maintained at the temperature of about 500 to 1000° C. for up to about 12 hours prior to step (c).

14. The method of claim 10, wherein the delithiated cathode compound comprises a lithium transition metal oxide that is at least partially delithiated.

15. The method of claim 14, wherein the lithium transition metal oxide comprises at least one transition metal selected from the group consisting of Ni, Mn, and Co.

16. The method of claim 10, wherein the delithiated cathode material comprises a composition of empirical formula Li₁₋ₓMO₂, wherein M comprises a transition metal, and 0<x<0.5.

17. The method of claim 10, wherein the heating is performed in a fluidized bed reactor or a rotary kiln.

18. The method of claim 10, wherein the binder comprises poly(vinylidene difluoride).

19. A cathode for a lithium battery comprising the lithiated cathode active material recovered in step (d) of the method of claim 1 and carbon coated on a metal current collector with a polymeric binder.

20. A lithium electrochemical cell comprising an anode, the cathode of claim 19, a lithium conductive separator between the anode and the cathode, and a lithium containing electrolyte contacting the anode, the cathode, and the separator.

21. A lithium battery comprising a plurality of the electrochemical cells of claim 20 electrically connected in series, in parallel, or in both series and parallel.
